(19) United States
(12) Patent Application Publication
(10) Pub. No.: US 2026/0291065 A1
(43) Pub. Date: Sep. 24, 2026

(54) ZIPPER DEVICE AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 19/190,405

(22) Filed: Apr. 25, 2025

(30) Foreign Application Priority Data
Mar. 20, 2025 (TW) 114110410

(51) Int. Cl. H01Q 5/20; A44B 19/26; H01Q 15/14

(52) U.S. Cl. CPC H01Q 5/20; A44B 19/26; H01Q 15/14

(57) ABSTRACT

A zipper device includes an antenna structure, a first metal tooth, and a reflector. The antenna structure is coupled to a signal source. The first metal tooth is adjacent to the antenna structure. The first metal tooth is used as a first director. The reflector is adjacent to the antenna structure. The antenna structure is disposed between the first metal tooth and the reflector. The first metal tooth and the reflector are configured to adjust the radiation pattern of the antenna structure.

### CROSS REFERENCE TO RELATED APPLICATIONS

This application claims priority of Taiwan Patent Application No. 114110410 filed on Mar. 20, 2025, the entirety of which is incorporated by reference herein.

### BACKGROUND OF THE INVENTION

### Field of the Invention

The invention relates to a zipper device, and more particularly, to a zipper device with a wireless communication function and a communication method thereof.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700MHz, 850MHz, 900MHz, 1800MHz, 1900MHz, 2100MHz, 2300MHz, and 2500MHz. Some devices cover a small wireless communication area; these include mobile phones using Wi-Fi systems and using frequency bands of 2.4GHz, 5.2GHz, and 5.8GHz.

Antennas are indispensable elements for wireless communication. If an antenna for signal reception and transmission has insufficient operational bandwidth, it may degrade the communication quality of the mobile device. Accordingly, it has become a critical challenge for designers to design a small-size, wideband antenna structure.

### BRIEF SUMMARY OF THE INVENTION

In an exemplary embodiment, the invention is directed to a zipper device that includes an antenna structure, a first metal tooth, and a reflector. The antenna structure is coupled to a signal source. The first metal tooth is adjacent to the antenna structure. The first metal tooth is used as a first director. The reflector is adjacent to the antenna structure. The antenna structure is disposed between the first metal tooth and the reflector. The first metal tooth and the reflector are configured to adjust the radiation pattern of the antenna structure.

In some embodiments, the antenna structure includes a first radiation element and a second radiation element. The first radiation element is coupled to the positive electrode of the signal source. The second radiation element is coupled to the negative electrode of the signal source.

In some embodiments, the first metal tooth substantially has a variable-width straight-line shape or a U-shape.

In some embodiments, the zipper device further includes a first nonconductive tooth disposed between the antenna structure and the first metal tooth.

In some embodiments, the zipper device further includes a second metal tooth disposed adjacent to the first metal tooth. The second metal tooth is used as a second director.

In some embodiments, the second metal tooth substantially has a variable-width straight-line shape or a U-shape.

In some embodiments, the zipper device further includes a second nonconductive tooth disposed between the first metal tooth and the second metal tooth.

In some embodiments, the antenna structure covers an operational frequency band. The operational frequency band is from 5150MHz to 7125MHz.

In some embodiments, the length of each of the first radiation element and the second radiation element is substantially equal to 0.25 wavelength of the operational frequency band.

In some embodiments, the length of the first metal tooth is from 0.2 to 0.4 wavelength of the operational frequency band.

In some embodiments, the length of the second metal tooth is from 0.2 to 0.4 wavelength of the operational frequency band.

In some embodiments, the length of the reflector is from 0.5 to 0.7 wavelength of the operational frequency band.

In some embodiments, the distance between the antenna structure and the first metal tooth is from 0.1 to 0.2 wavelength of the operational frequency band.

In some embodiments, the distance between the antenna structure and the reflector is from 0.1 to 0.2 wavelength of the operational frequency band.

In some embodiments, the distance between the first metal tooth and the second metal tooth is from 0.1 to 0.2 wavelength of the operational frequency band.

In some embodiments, the zipper device further includes a metal ground plane disposed adjacent to the antenna structure, the first metal tooth, and the reflector.

In some embodiments, the zipper device further includes a first nonconductive layer and a second nonconductive layer. The first nonconductive layer is disposed on the top surface of the first metal tooth. The second nonconductive layer is disposed on the bottom surface of the first metal tooth.

In some embodiments, the zipper device further includes a third nonconductive layer and a fourth nonconductive layer. The third nonconductive layer is disposed on the top surface of the second metal tooth. The fourth nonconductive layer is disposed on the bottom surface of the second metal tooth.

In some embodiments, the first nonconductive layer, the second nonconductive layer, the third nonconductive layer, and the fourth nonconductive layer are configured to prevent the first metal tooth from directly touching the second metal tooth.

In another preferred embodiment, the invention is directed to a communication method that includes the steps of: providing an antenna structure, a first metal tooth, and a reflector, wherein the antenna structure is coupled to a signal source, wherein the first metal tooth and the reflector are adjacent to the antenna structure, and wherein the antenna structure is disposed between the first metal tooth and the reflector; using the first metal tooth as a first director; and adjusting a radiation pattern of the antenna structure by the first metal tooth and the reflector.

### BRIEF DESCRIPTION OF DRAWINGS

FIG. 1 is a diagram of a zipper device according to an embodiment of the invention;

FIG. 2 is a diagram of a zipper device according to an embodiment of the invention;

FIG. 3 is a diagram of a zipper device according to an embodiment of the invention; and

FIG. 4 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to…”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

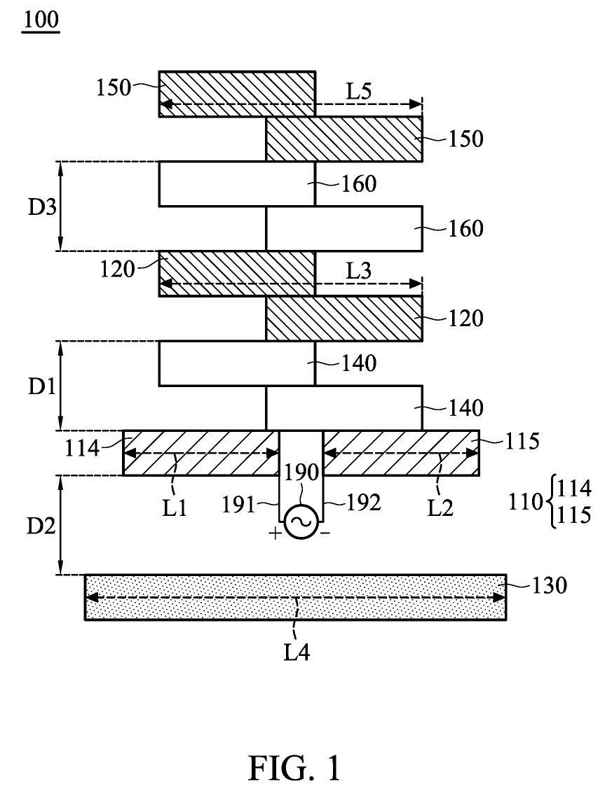

FIG. 1 is a diagram of a zipper device 100 according to an embodiment of the invention. The zipper device 100 may be applied to any clothing element, such as a jacket, a shirt, a pair of pants, or a skirt. In the embodiment of FIG. 1, the zipper device 100 at least includes an antenna structure 110, a first metal tooth 120, and a reflector 130. The antenna structure 110 and the reflector 130 may both be made of metal materials, such as copper, silver, aluminum, iron, or their alloys. It should be understood that the zipper device 100 may further include other components, such as a slider, a puller and/or a connector, although they are not displayed in FIG. 1.

The antenna structure 110 is coupled to a signal source 190. For example, the signal source 190 may be an RF (Radio Frequency) module for exciting the antenna structure 110. It should be understood that the shape and type of the antenna structure 110 are not limited in the invention. For example, the antenna structure 110 may be a dipole antenna, a monopole antenna, a patch antenna, a loop antenna, or a PIFA (Planar Inverted F Antenna).

In some embodiments, the antenna structure 110 includes a first radiation element 114 and a second radiation element 115. Specifically, the signal source 190 has a positive electrode 191 and a negative electrode 192. The first radiation element 114 is coupled to the positive electrode 191 of the signal source 190. The second radiation element 115 is coupled to the negative electrode 192 of the signal source 190. However, the invention is not limited thereto. In alternative embodiments, the positive electrode 191 and the negative electrode 192 of the signal source 190 are exchanged with each other, but it does not affect the function of the signal source 190.

For example, the first metal tooth 120 may substantially have a variable-width straight-line shape. The first metal tooth 120 is adjacent to the antenna structure 110. The first metal tooth 120 is used as a first director. In some embodiments, the first metal tooth 120 includes one or more metal strips coupled with each other. It should also be noted that the term “adjacent” or “close” over the disclosure means that the distance (spacing) between two corresponding elements is smaller than a predetermined distance (e.g., 10mm or the shorter), but often does not mean that the two corresponding elements directly touch each other (i.e., the aforementioned distance/spacing between them is reduced to 0).

For example, the reflector 130 may substantially have an equal-width straight-line shape. The reflector 130 is adjacent to the antenna structure 110. The antenna structure 110 is disposed between the first metal tooth 120 and the reflector 130. According to practical measurements, the first metal tooth 120 and the reflector 130 are configured to adjust the radiation pattern of the antenna structure 110, such that the main beam of the antenna structure 110 is toward the desired direction.

In some embodiments, the zipper device 100 further includes a first nonconductive tooth 140. The first nonconductive tooth 140 is disposed between the antenna structure 110 and the first metal tooth 120. For example, the first nonconductive tooth 140 may directly touch the antenna structure 110 and the first metal tooth 120. However, the first nonconductive tooth 140 does not negatively affect the radiation performance of the antenna structure 110.

In some embodiments, the zipper device 100 further includes a second metal tooth 150. The second metal tooth 150 is adjacent to the first metal tooth 120. The second metal tooth 150 is used as a second director. For example, the second metal tooth 150 may substantially have another variable-width straight-line shape, which may be substantially parallel to the first metal tooth 120. According to practical measurements, the second metal tooth 150 is also configured to modify the radiation pattern of the antenna structure 110.

In some embodiments, the zipper device 100 further includes a second nonconductive tooth 160. The second nonconductive tooth 160 is disposed between the first metal tooth 120 and the second metal tooth 150. For example, the second nonconductive tooth 160 may directly touch the first metal tooth 120 and the second metal tooth 150. However, the second nonconductive tooth 160 does not negatively affect the radiation performance of the antenna structure 110. It should be noted that the first metal tooth 120 and the second metal tooth 150 are interleaved with the first nonconductive tooth 140 and the second nonconductive tooth 160. In other embodiments, the zipper device 100 further include more metal teeth and more nonconductive teeth (not shown).

In some embodiments, the antenna structure 110 of the zipper device 100 can cover an operational frequency band. For example, the operational frequency band may be from 5150MHz to 7125MHz. Accordingly, the zipper device 100 can support at least the wideband operations of WLAN (Wireless Local Area Network) and Wi-Fi 6E.

In some embodiments, the operational principles of the antenna structure 110 of the zipper device 100 will be described as follows. The antenna structure 110 is configured to generate an electromagnetic wave. The reflector 130 is configured to reflect the electromagnetic wave. The first metal tooth 120 and the second metal tooth 150 are configured to guide the electromagnetic wave. Accordingly, the antenna structure 110 is capable of providing higher radiation gain. Since the zipper device 100 with the function of wireless communication is capable of being integrated with any clothing element of a user, it not only supports the desired wideband operations but also helps to reduce the overall antenna size.

In some embodiments, the element sizes of the zipper device 100 will be described as follows. The length L1 of the first radiation element 114 may be substantially equal to 0.25 wavelength (λ/4) of the operational frequency band of the antenna structure 110 of the zipper device 100. The length L2 of the second radiation element 115 may be substantially equal to 0.25 wavelength (λ/4) of the operational frequency band of the antenna structure 110 of the zipper device 100. The length L3 of the first metal tooth 120 may be from 0.2 to 0.4 wavelength (λ/5 ~ 2λ/5) of the operational frequency band of the antenna structure 110 of the zipper device 100. The length L4 of the reflector 130 may be from 0.5 to 0.7 wavelength (λ/2 ~ 7λ/10) of the operational frequency band of the antenna structure 110 of the zipper device 100. The length L5 of the second metal tooth 150 may be from 0.2 to 0.4 wavelength (λ/5 ~ 2λ/5) of the operational frequency band of the antenna structure 110 of the zipper device 100. The distance D1 between the antenna structure 110 and the first metal tooth 120 may be from 0.1 to 0.2 wavelength (λ/10 ~ λ/5) of the operational frequency band of the antenna structure 110 of the zipper device 100. The distance D2 between the antenna structure 110 and the reflector 130 may be from 0.1 to 0.2 wavelength (λ/10 ~ λ/5) of the operational frequency band of the antenna structure 110 of the zipper device 100. The distance D3 between the first metal tooth 120 and the second metal tooth 150 may be from 0.1 to 0.2 wavelength (λ/10 ~ λ/5) of the operational frequency band of the antenna structure 110 of the zipper device 100. The above ranges of element sizes are calculated and obtained according to many experimental results, and they help to optimize the operational bandwidth and the impedance matching of the antenna structure 110 of the zipper device 100 and also to minimize the overall size of the zipper device 100.

In some embodiments, the first metal tooth 120 on the zipper device 100 is printed on a dielectric material by using printing or LDS (Laser Direct Structuring) technology, so as to further increase the design freedom of the first metal tooth 120.

The following embodiments will introduce different configurations and detail structural features of the zipper device 100. It should be understood that these figures and descriptions are merely exemplary, rather than limitations of the invention.

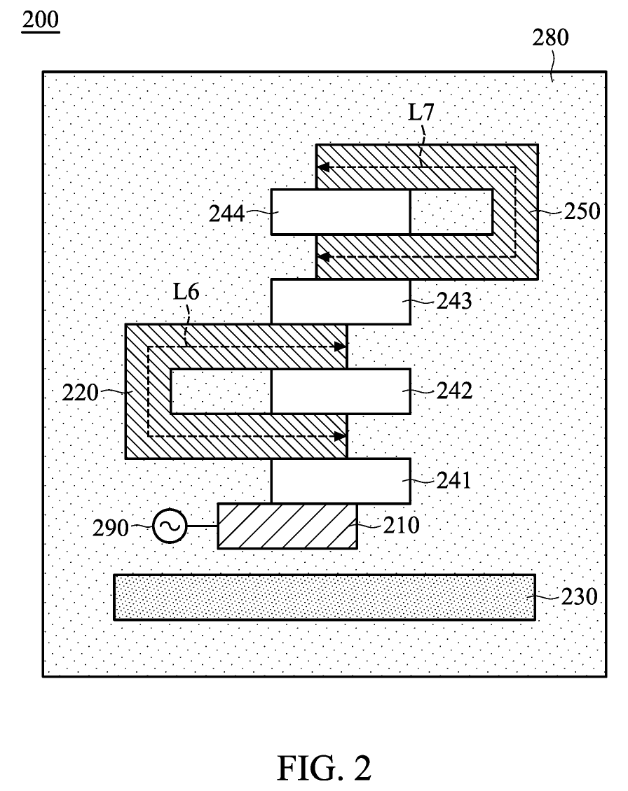

FIG. 2 is a diagram of a zipper device 200 according to an embodiment of the invention. FIG. 2 is similar to FIG. 1. In the embodiment of FIG. 2, the zipper device 200 includes an antenna structure 210, a first metal tooth 220, a reflector 230, a plurality of nonconductive teeth 241, 242, 243 and 244, a second metal tooth 250, and a metal ground plane 280. The antenna structure 210 is coupled to a signal source 290. For example, the first metal tooth 220 may substantially have a U-shape. The first metal tooth 220 is adjacent to the antenna structure 210. The first metal tooth 220 is used as a first director. In some embodiments, the length L6 of the first metal tooth 220 may be from 0.8 to 1 wavelength (4λ/5 ~ 1λ) of the operational frequency band of the antenna structure 210 of the zipper device 200. The reflector 230 is adjacent to the antenna structure 210. The antenna structure 210 is disposed between the first metal tooth 220 and the reflector 230. For example, the second metal tooth 250 may substantially have another U-shape. The second metal tooth 250 is adjacent to the first metal tooth 220. The second metal tooth 250 is used as a second director. In some embodiments, the length L7 of the second metal tooth 250 may be from 0.8 to 1 wavelength (4λ/5 ~ 1λ) of the operational frequency band of the antenna structure 210 of the zipper device 200. In addition, the direction of the open side of the first metal tooth 220 may be substantially opposite to that of the open side of the second metal tooth 250. It should be noted that the first metal tooth 220 and the second metal tooth 250 are interleaved with the nonconductive teeth 241, 242, 243 and 244. The metal ground plane 280 is adjacent to the antenna structure 210, the first metal tooth 220, the reflector 230, and the second metal tooth 250. In some embodiments, the antenna structure 210, the first metal tooth 220, the reflector 230, and the second metal tooth 250 have a plurality of vertical projections on the metal ground plane 280, and all of the vertical projections are completely inside the metal ground plane 280. According to practical measurements, the first metal tooth 220 and the second metal tooth 250 with different shapes can fine-tune the radiation pattern of the antenna structure 210, and the incorporation of the metal ground plane 280 can help to further enhance the radiation gain of the antenna structure 210. Other features of the zipper device 200 of FIG. 2 are similar to those of the zipper device 100 of FIG. 1. Accordingly, the two embodiments can achieve similar levels of performance.

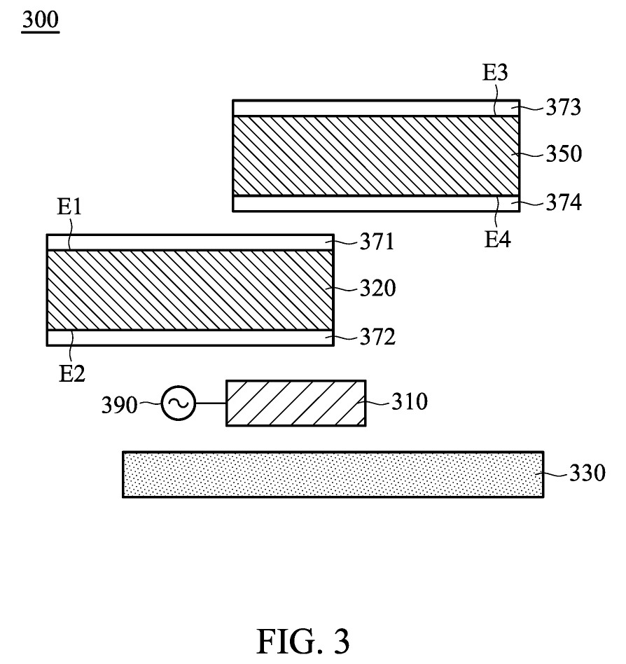

FIG. 3 is a diagram of a zipper device 300 according to an embodiment of the invention. FIG. 3 is similar to FIG. 1. In the embodiment of FIG. 3, the zipper device 300 includes an antenna structure 310, a first metal tooth 320, a reflector 330, a second metal tooth 350, a first nonconductive layer 371, a second nonconductive layer 372, a third nonconductive layer 373, and a fourth nonconductive layer 374. The antenna structure 310 is couple to a signal source 390. Specifically, the first metal tooth 320 has a top surface E1 and a bottom surface E2 which are opposite to each other. The first nonconductive layer 371 is disposed on the top surface E1 of the first metal tooth 320. The second nonconductive layer 372 is disposed on the bottom surface E2 of the first metal tooth 320. In addition, the second metal tooth 350 has a top surface E3 and a bottom surface E4 which are opposite to each other. The third nonconductive layer 373 is disposed on the top surface E3 of the second metal tooth 350. The fourth nonconductive layer 374 is disposed on the bottom surface E4 of the second metal tooth 350. It should be noted that the first nonconductive layer 371, the second nonconductive layer 372, the third nonconductive layer 373, and the fourth nonconductive layer 374 are configured to prevent the first metal tooth 320 from directly touching the second metal tooth 350. With such a design, the zipper device 300 can use no nonconductive teeth, thereby increasing the antenna design flexibility and reducing the overall manufacturing cost. Other features of the zipper device 300 of FIG. 3 are similar to those of the zipper device 100 of FIG. 1. Accordingly, the two embodiments can achieve similar levels of performance.

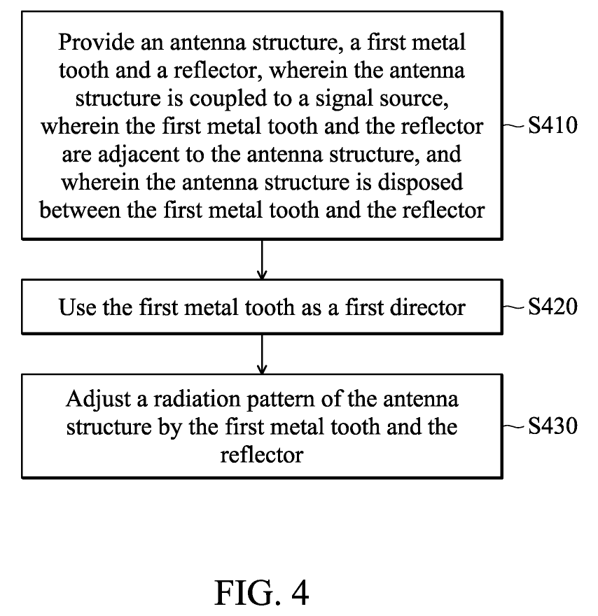

FIG. 4 is a flowchart of a communication method according to an embodiment of the invention. To begin, in step S410, an antenna structure, a first metal tooth, and a reflector are provided. The antenna structure is coupled to a signal source. The first metal tooth and the reflector are adjacent to the antenna structure. The antenna structure is disposed between the first metal tooth and the reflector. In step S420, the first metal tooth is used as a first director. Finally, in step S430, the radiation pattern of the antenna structure is adjusted by the first metal tooth and the reflector. It should be understood that these steps are not required to be performed in order, and every feature of the embodiments of FIGS. 1-3 may be applied to the communication method of FIG. 4.

The invention proposes a novel zipper device and a novel communication method. In comparison to the conventional design, the invention at least has the advantages of small size, wide bandwidth, and being easily integrated with any clothing element. Therefore, the invention is suitable for application in a variety of devices.

Note that the above element sizes and frequency ranges are not limitations of the invention. An antenna designer can fine-tune these setting values according to different requirements. It should be understood that the zipper device and the communication method of the invention are not limited to the configurations of FIGS. 1-4. The invention may include any one or more features of any one or more embodiments of FIGS. 1-4. In other words, not all of the features displayed in the figures should be implemented in the zipper device and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A zipper device, comprising:
an antenna structure, coupled to a signal source;
a first metal tooth, disposed adjacent to the antenna structure, wherein the first metal tooth is used as a first director; and
a reflector, disposed adjacent to the antenna structure, wherein the antenna structure is disposed between the first metal tooth and the reflector;
wherein the first metal tooth and the reflector are configured to adjust a radiation pattern of the antenna structure.

2. The zipper device as claimed in claim 1, wherein the antenna structure comprises a first radiation element and a second radiation element, the first radiation element is coupled to a positive electrode of the signal source, and the second radiation element is coupled to a negative electrode of the signal source.

3. The zipper device as claimed in claim 1, wherein the first metal tooth substantially has a variable-width straight-line shape or a U-shape.

4. The zipper device as claimed in claim 1, further comprising:
a first nonconductive tooth, disposed between the antenna structure and the first metal tooth.

5. The zipper device as claimed in claim 2, further comprising:
a second metal tooth, disposed adjacent to the first metal tooth, wherein the second metal tooth is used as a second director.

6. The zipper device as claimed in claim 5, wherein the second metal tooth substantially has a variable-width straight-line shape or a U-shape.

7. The zipper device as claimed in claim 5, further comprising:
a second nonconductive tooth, disposed between the first metal tooth and the second metal tooth.

8. The zipper device as claimed in claim 5, wherein the antenna structure covers an operational frequency band, and the operational frequency band is from 5150MHz to 7125MHz.

9. The zipper device as claimed in claim 8, wherein a length of each of the first radiation element and the second radiation element is substantially equal to 0.25 wavelength of the operational frequency band.

10. The zipper device as claimed in claim 8, wherein a length of the first metal tooth is from 0.2 to 0.4 wavelength of the operational frequency band.

11. The zipper device as claimed in claim 8, wherein a length of the second metal tooth is from 0.2 to 0.4 wavelength of the operational frequency band.

12. The zipper device as claimed in claim 8, wherein a length of the reflector is from 0.5 to 0.7 wavelength of the operational frequency band.

13. The zipper device as claimed in claim 8, wherein a distance between the antenna structure and the first metal tooth is from 0.1 to 0.2 wavelength of the operational frequency band.

14. The zipper device as claimed in claim 8, wherein a distance between the antenna structure and the reflector is from 0.1 to 0.2 wavelength of the operational frequency band.

15. The zipper device as claimed in claim 8, wherein a distance between the first metal tooth and the second metal tooth is from 0.1 to 0.2 wavelength of the operational frequency band.

16. The zipper device as claimed in claim 1, further comprising:
a metal ground plane, disposed adjacent to the antenna structure, the first metal tooth and the reflector.

17. The zipper device as claimed in claim 5, further comprising:
a first nonconductive layer, disposed on a top surface of the first metal tooth; and
a second nonconductive layer, disposed on a bottom surface of the first metal tooth.

18. The zipper device as claimed in claim 17, further comprising:
a third nonconductive layer, disposed on a top surface of the second metal tooth; and
a fourth nonconductive layer, disposed on a bottom surface of the second metal tooth.

19. The zipper device as claimed in claim 18, wherein the first nonconductive layer, the second nonconductive layer, the third nonconductive layer and the fourth nonconductive layer are configured to prevent the first metal tooth from directly touching the second metal tooth.

20. A communication method, comprising the steps of:
providing an antenna structure, a first metal tooth and a reflector, wherein the antenna structure is coupled to a signal source, wherein the first metal tooth and the reflector are adjacent to the antenna structure, and wherein the antenna structure is disposed between the first metal tooth and the reflector;
using the first metal tooth as a first director; and
adjusting a radiation pattern of the antenna structure by the first metal tooth and the reflector.
